(19) United States
(12) Patent Application Publication
(10) Pub. No.: US 2014/0354783 A1
(43) Pub. Date: Dec. 4, 2014

(54) Human-Perspective Stereoscopic Camera

(71) Applicant: John Peter Hall, Surfside, FL (US)

(72) Inventor: John Peter Hall, Surfside, FL (US)

(21) Appl. No.: 14/459,738

(22) Filed: Aug. 14, 2014

Related U.S. Application Data
(63) Continuation-in-part of application No. 13/517,590, filed on Jun. 13, 2012.
(60) Provisional application No. 61/496,131, filed on Jun. 13, 2011.

(51) Int. Cl. H04N 13/02; G02B 23/12

(52) U.S. Cl. CPC H04N 13/0203; G02B 23/12
USPC 348/49

(57) ABSTRACT

A human-perspective stereoscopic camera is an apparatus that is used to capture stereoscopic viewing material that is from the perspective of one person's eyes. The apparatus mainly comprises a left telescopic tube, a right telescopic tube, a translational pivoting mount, a lateral movement mechanism, and a platform with a channel as a support structure. The left telescopic tube and the right telescopic tube each comprise a first cylinder, a second cylinder, and an optics assembly. The first cylinder and the second cylinder are the means for the telescopic movement. The optics assembly comprises a lens, a digital single-lens reflex camera, a camera mount, a plate, and a pole. The configuration for the components of the optics assembly allows the left telescopic tube and the right telescopic tube to capture stereoscopic viewing material from the perspective of one person's eyes.

The current application is a continuation-in-part of and claims a priority to Ser. No. 13/517,590 filed on Jun. 13, 2012, which claims a priority to 61/496,131 filed on Jun. 13, 2011.

### FIELD OF THE INVENTION

The present invention relates generally to stereoscopic cameras. More specifically, the present invention is a new type of stereoscopic camera that allows the observer to see through the eyes of a specific person and follow the movement of that person's eyes.

### BACKGROUND OF THE INVENTION

The field of stereoscopic viewing, while first introduced by Charles Wheatstone in the early 1800s, has since achieved a resurgence with the new popularity of stereoscopic film. Stereoscopic images attempt to recreate in captured film the human ability to perceive depth, primarily by imitation of the natural human perception of stereopsis. Stereopsis is the effect of the human brain processing two different images from slightly separated eyes. By providing two separate images for viewing, and projecting one image to each eye, stereoscopic viewing achieves binocular disparity due to minor differences between the images, inducing the human brain to process these images as it would typical human vision, and giving the illusion of natural depth even to flat images.

The taking of stereoscopic photographs, or the shooting of stereoscopic film, is achieved by taking two images of the same subject, with the only difference being a slight variation in the position of the camera to the subject, maintaining the same distance to the subject but changing the location from which the second image is taken. While this can be achieved for still objects by moving a single camera to different positions physically and taking multiple photos, to capture moving images, such as is required in creating film, two cameras must simultaneously view the same subject from different positions, thus allowing separate images to be taken at the same time. The current method for achieving this effect involves mounting two cameras a fixed distance apart, typically 60 to 70 millimeters to simulate the distance between the centers of a pair of human eyes. The cameras are then controlled so that it is possible to take simultaneous photographs with both cameras, creating paired images that can be converted to a form that allows stereoscopic viewing.

To achieve the largest functional range, the cameras of the paired stereoscopic photography method are fixed so that the functional axis of each camera is generally parallel to the other. This means that control of image focus is achieved through the manipulation of the focal point of the camera lens, the method used in traditional photography. The human eye, in addition to controlling focus through changing the form of a lens, is also able to create focus on a specific subject through the inward turning of the eyes at slight angles, such that the center of each retina is pointed directly at the subject. This is referred to as vergence movement—to be in the process of becoming something else—and cannot be replicated by cameras fixed to be parallel.

Stereoscopic photography is the conscious effort to simulate as closely as possible the function of the human eye, in order to allow accurate replication of the views achieved by the human eye during image viewing. The present invention attempts to further the imitation achieved by previous stereoscopic camera fixtures towards the end of representing human vision more faithfully in stereoscopic images, when desired. Traditional stereoscopic cameras are unable to achieve the effect of vergence as experienced by the human eye, and as such the focus of images is still determined purely by changes to the focus of the lens capturing the shot. The present invention is a means by which the vergence of the human eye can be replicated in stereoscopic photography for greater imitation of natural human vision, providing an apparatus and method to control the relative angle of a stereoscopic photography unit comprised of two linked cameras.

The intention of recreating the vergence effect is to replicate the ability of the human eye to naturally focus on specific subjects even within a larger scene. While in traditional stereoscopic photography, all objects at the same distance will be seen with the same focus, the effect of vergence between the two cameras of the present invention will place the same natural emphasis on a single subject as that found when a human views an object. The present invention is also designed to be controllable in both rapid and fine adjustments, allowing quick or subtle changes in vergence as is considered necessary by the photographer. The ability to change the vergence of the present invention while in use means that it is well designed for use with film and the capture of moving images. Changes to the angles between stereoscopic cameras previously would have required the disassembly and precise reconstruction of the stereoscopic housing device, if manipulation of the vergence angle was possible at all.

Another component of human vision absent from previous stereoscopic devices is the limited range of focus created with human vision. While a camera, and thus a photographic image, is able to maintain focus over a large field of view, the human eye has limited focus with regards to both distance and area, meaning that there exists a smaller area than the total perceived area on which human vision is fully focused. This is most apparent when observing blurred and indistinct images in human peripheral vision. Alongside the inclusion of a means to recreate vergence, the present invention is able to replicate the smaller focal area of human vision, thus providing further simulation of human vision for stereoscopic viewing, an effect which cannot be created by traditional stereoscopic cameras.

While not all stereoscopic photography intends to recreate the conditions of human viewing with a high degree of accuracy, the ability to do so using the present invention will introduce greater ability for artistic manipulation of stereoscopic images in both photography and film. By introducing the capacity to mimic human vision, a photographer or film-maker can create a viewing experience which more accurately reflects the perceptions of an individual person, and can be utilized for entertainment, education, or any other demand of the film and photography market.

### BRIEF DESCRIPTION OF THE DRAWINGS

FIG. 1A is a perspective view of the present invention.

FIG. 1B is a perspective view of the present invention, wherein the present invention is shown with a viewfinder.

FIG. 1C is a perspective view of the present invention, wherein the present invention is shown with a strengthening bracket for each telescopic tube.

FIG. 1D is a perspective view of the present invention, wherein the strengthening bracket for each telescopic tube is transparently illustrated.

FIG. 2 is a perspective view of the left telescopic tube, the right telescopic tube, the translational pivoting mount, and the lateral movement mechanism.

FIG. 3 is a side view of either of the telescopic tubes.

FIG. 4 is a front view of the left telescopic tube, the right telescopic tube, and the lateral movement mechanism without the translation pivoting mount.

FIG. 5 is a top perspective view of the platform and the channel.

FIG. 6 is a bottom perspective view of the platform and the channel.

FIG. 7A is a top view of the left telescopic tube, the right telescopic tube, and the lateral movement mechanism, wherein the left telescopic tube and the right telescopic tube are parallel to each other.

FIG. 7B is a transparent top view of the left telescopic tube, the right telescopic tube, and the lateral movement mechanism that shows the optics assembly.

FIG. 8A is a top view of the left telescopic tube, the right telescopic tube, and the lateral movement mechanism, wherein the left telescopic tube and the right telescopic tube are angled towards each other.

FIG. 8B is a transparent top view of the left telescopic tube, the right telescopic tube, and the lateral movement mechanism that shows the optics assembly.

FIG. 9A is a top view of the present invention, wherein the left telescopic tube and the right telescopic tube are parallel to each other.

FIG. 9B is a top view of the present invention, wherein the left telescopic tube and the right telescopic tube are angled towards each other.

FIG. 10A is a front schematic view of the left telescopic tube and the right telescopic tube showing an alternate embodiment for the optics assembly.

FIG. 10B is a top schematic view of the left telescopic tube and the right telescopic tube showing an alternate embodiment for the optics assembly.

### DETAIL DESCRIPTIONS OF THE INVENTION

All illustrations of the drawings are for the purpose of describing selected versions of the present invention and are not intended to limit the scope of the present invention.

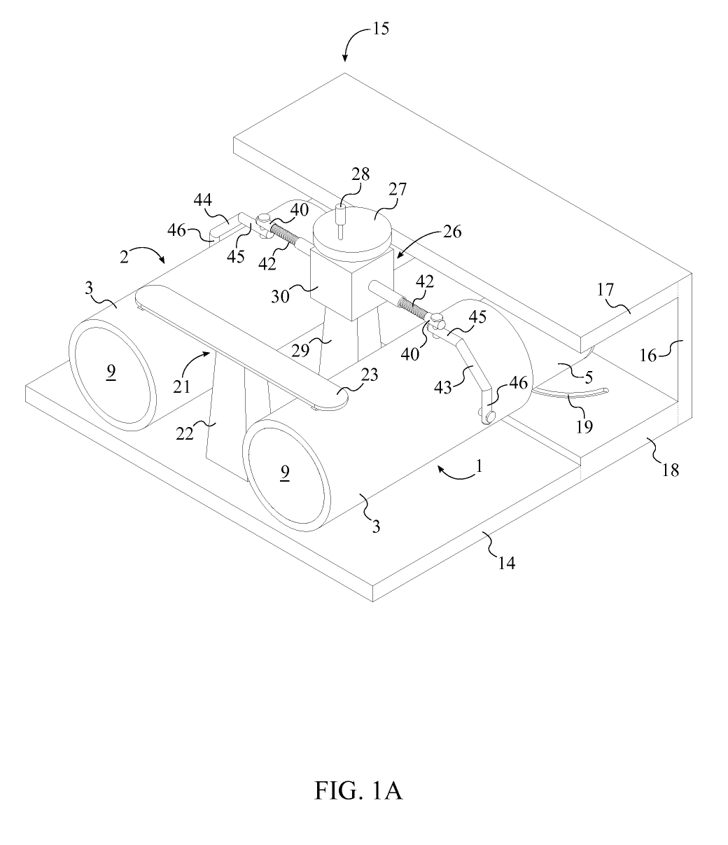

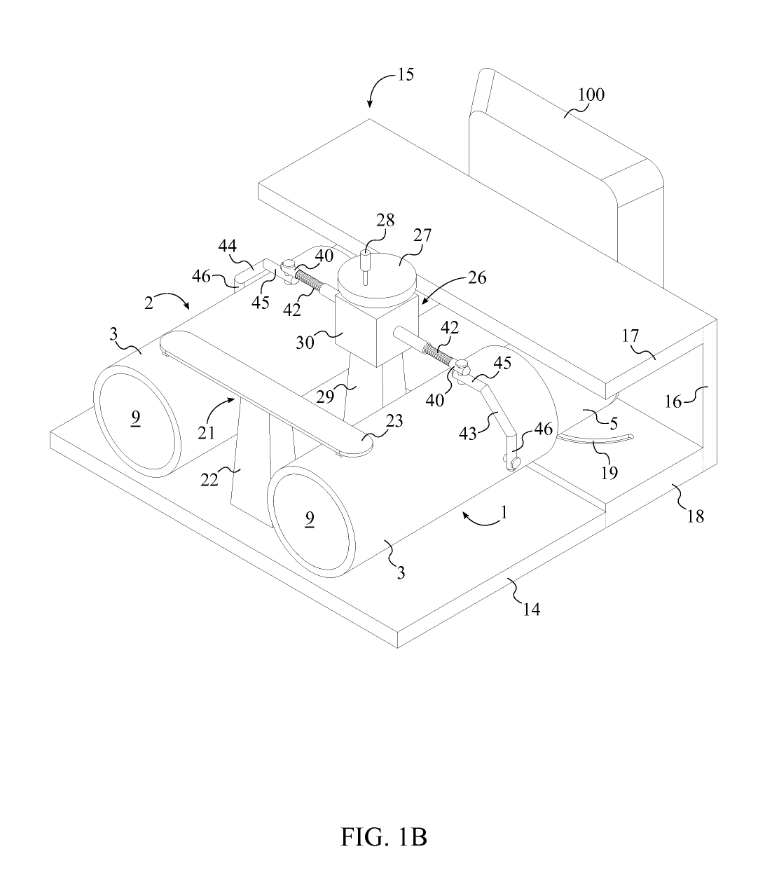

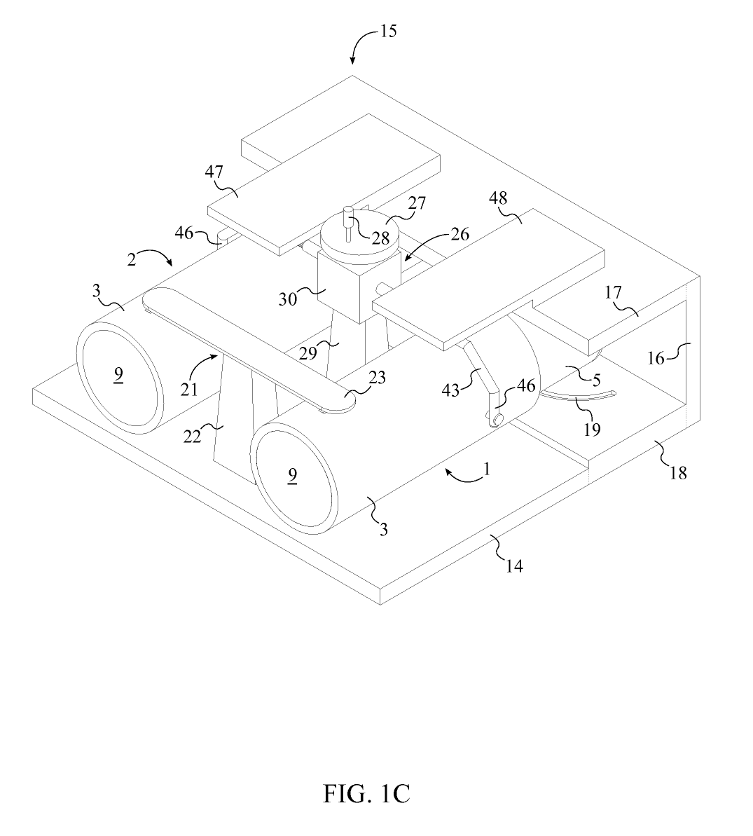

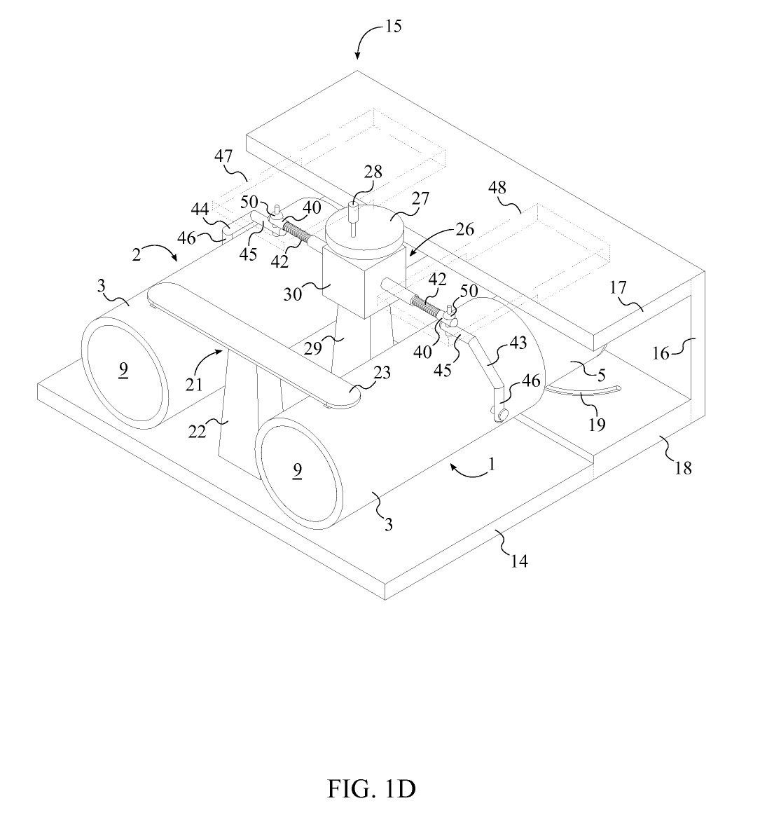

As can be seen in FIG. 1A, the present invention is a human-perspective stereoscopic camera, which is used to record a stereoscopic movie from the point of view of a left eye and a right eye focusing on far and near objects. The present invention mainly comprises a left telescopic tube 1, a right telescopic tube 2, a platform 14, a channel 15, a translational pivoting mount 21, and a lateral movement mechanism 26. The left telescopic tube 1 and the right telescopic tube 2 respectively mimic the movements of the left eye and the right eye. In addition, the left telescopic tube 1 and the right telescopic tube 2 respectively record the viewing material from the perspective of the left eye and the viewing material from the perspective of the right eye. The platform 14 and the channel 15 are used to properly position and support the components of the present invention. The translational pivoting mount 21 allows the front of the left telescopic tube 1 to pivot about a fixed point and allows the front of the right telescopic tube 2 to pivot about another fixed point. The lateral movement mechanism 26 provides the left telescopic tube 1 and the right telescopic tube 1 with equal lateral movement so that the left telescopic tube 1 and the right telescopic tube 2 can rotate about their respective fixed points.

In terms of the general orientation of the components, the platform 14 is positioned below and parallel to the left telescopic tube 1 and the right telescopic tube 2, which limits the movement of the left telescopic tube 1 and the right telescopic tube 2 to one plane. The second cylinder 5 of both the left telescopic tube 1 and the right telescopic tube 2 traverses into the channel 15, which again limits the movement of the left telescopic tube 1 and the right telescopic tube 2 to one plane. The channel 15 is connected adjacent to the platform 14 or behind the platform 14, which creates the base for all of the other components. Also in terms of the general orientation of the components, the translational pivoting mount 21 is positioned opposite of the channel 15 along the left telescopic tube 1 and the right telescopic tube 1, which prevents the front of the telescopic tubes from laterally moving and allows the back of the telescopic tubes to laterally move through the channel. The lateral movement mechanism 26 is positioned in between the translational pivoting mount 21 and the channel 15, which provides the back of the telescopic tubes with the means to move laterally through the channel 15. In addition, a viewfinder 100 and an eyecup, which are common cinematography components, are central connected to the channel opposite to the telescopic tube 1 and the right telescopic tube 2. As can be seen in FIG. 1B, the viewfinder 100 and the eyecup allow the user to orient the present invention in the proper direction so that the telescopic tube 1 and the right telescopic tube 2 can capture the correct stereoscopic image.

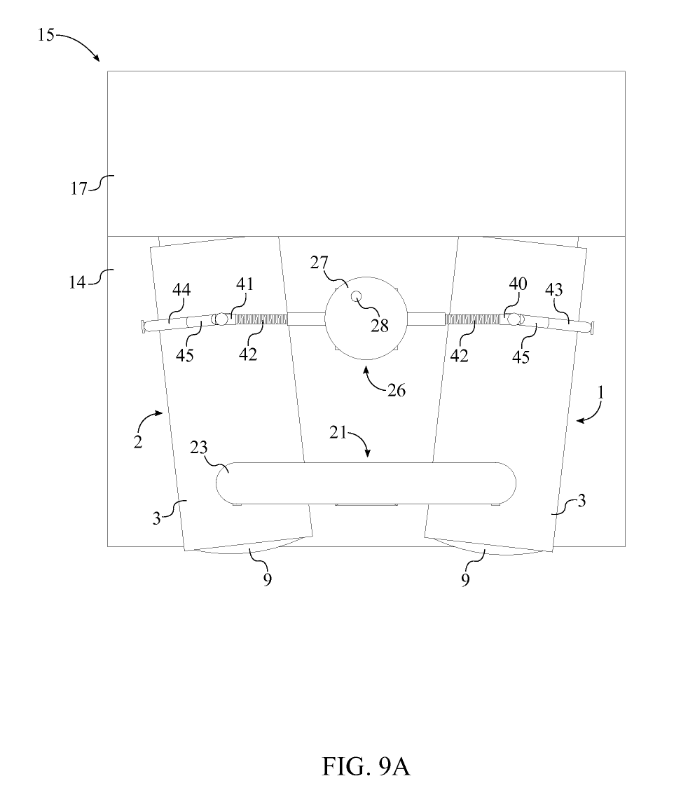

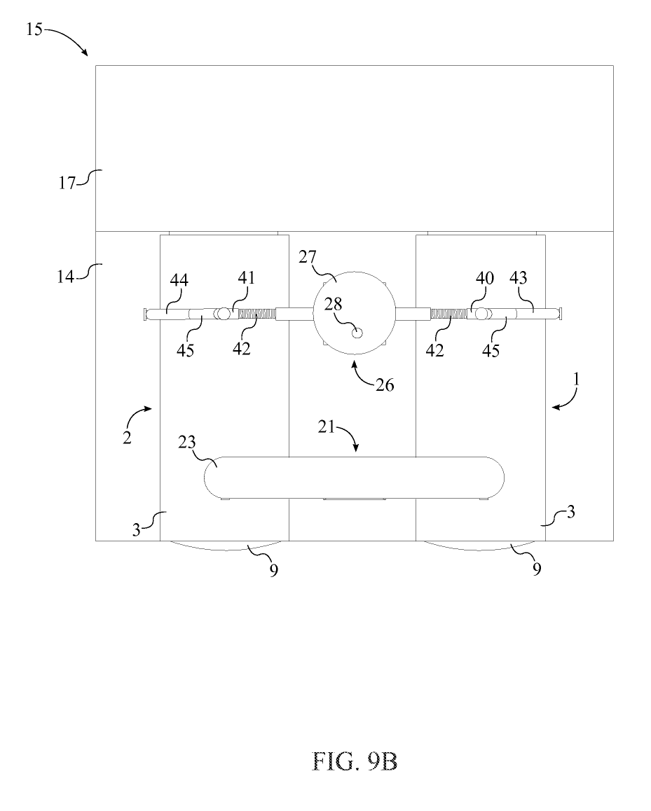

As can be seen in FIGS. 9A and 9B, the movement and the orientation of the left telescopic tube 1 and the right telescopic tube 2 allow the present invention to capture the stereoscopic viewing material. The left telescopic tube 1 and the right telescopic tube 2 each comprise a first cylinder 3, a second cylinder 5, and an optics assembly 8. The second cylinder 5 traverses into the first cylinder 3, which allows the second cylinder 5 to be sleeved by the first cylinder 3. The configuration of the second cylinder 5 and the first cylinder 3 allows the left telescopic tube 1 and the right telescopic tube 2 to adjust their length in order to compensate for different viewing objects being at different distances from the present invention.

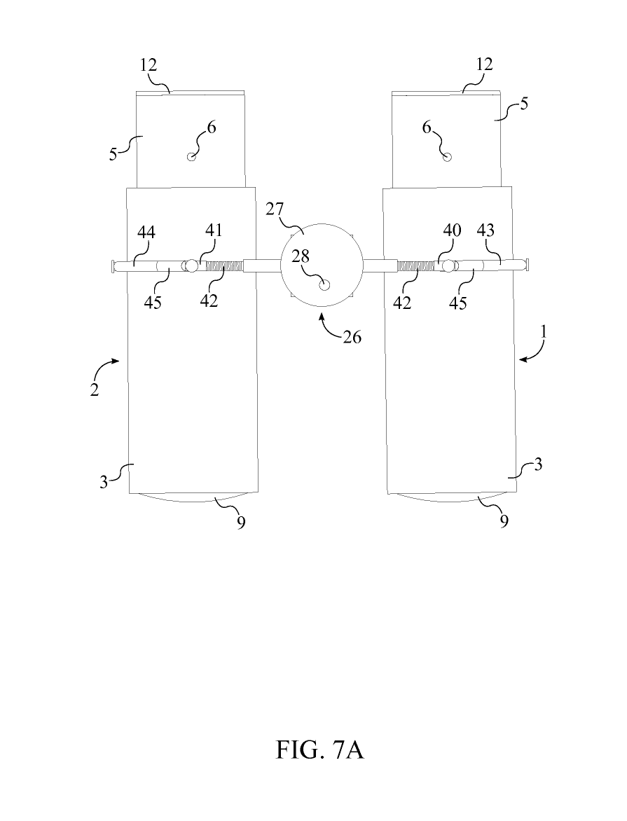

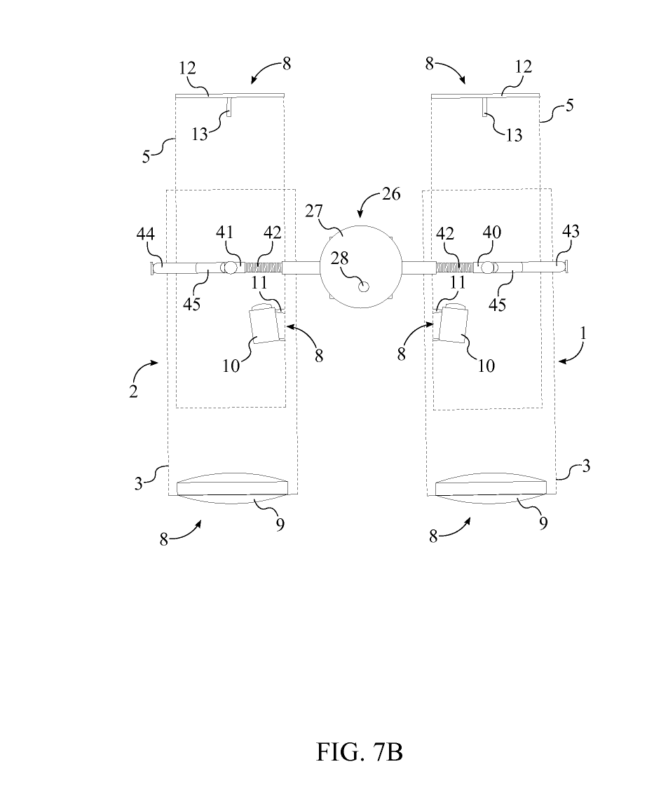

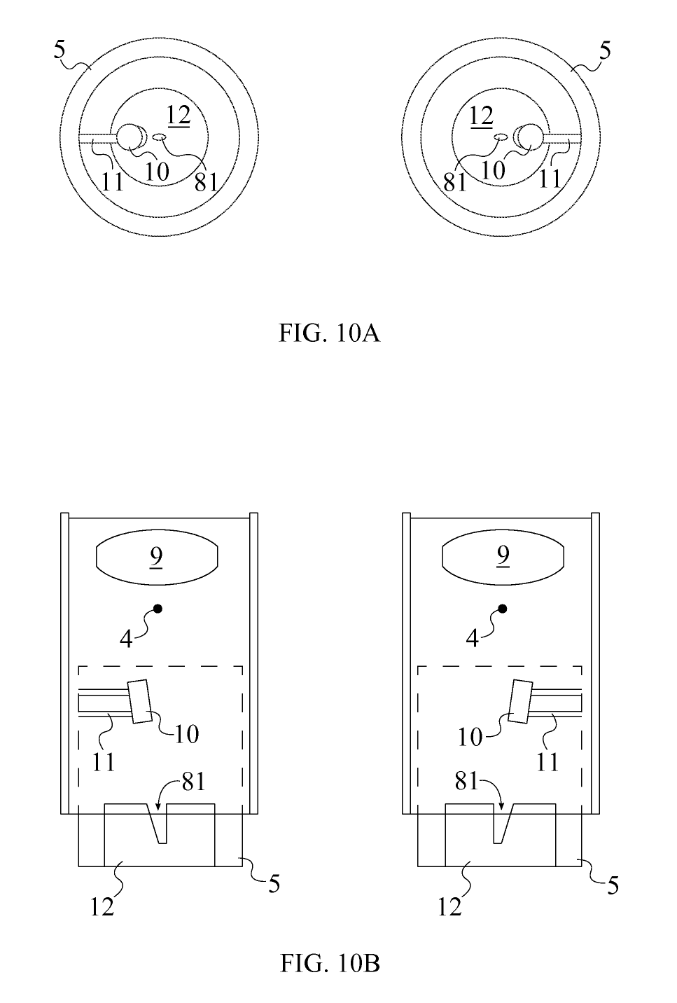

The optics assembly 8 allows the left telescopic tube 1 and the right telescopic tube 2 to record the stereoscopic viewing material. The optics assembly 8 comprises a lens 9, a digital single-lens reflex (DSLR) camera 10, a camera mount 11, a plate 12, and a pole 13, all of which is shown in FIGS. 7A and 7B. The lens 9 is used to converge the incoming light rays from a viewing object. Thus, the lens 9 is encircled by the front of the first cylinder 3 and is positioned opposite to the second cylinder 5. The light rays that converge through the lens 9 are projected onto the plate 12, which is where the light rays produce an unfocused image of the viewing object and the surrounding area. Thus, the plate 12 is encircled by the back of the second cylinder 5 and is positioned opposite to the first cylinder 3. The DSLR camera 10 of the left telescopic tube 1 is used to record the image that is projected into the left telescopic tube 1, and the DSLR camera 10 of the right telescopic tube 2 is used to record the image that is projected into the right telescopic tube 2. The DSLR camera 10 should be positioned far enough away from the plate 12 so that the DSLR camera can capture the entire viewing area of the plate. The DSLR camera is connected to the second cylinder 5 by the camera mount 11, which keeps the DSLR camera 10 at the same distance from the plate 12 while either the left telescopic tube 1 or the right telescopic tube 2 is changing length. The pole 13 is centrally positioned on the plate 12 and is connected normal to the plate 12, which allows the light rays converging from the lens 9 to project the center of the image on the end of the pole 13 opposite the plate 12. The end of the pole 9 opposite the plate 12 should be where the light rays from the viewing object converge at a focal point so that only the viewing object in the center of the image is in focus and the surround area is unfocused. The ends of the pole 13 for both the left telescopic tube 1 and the right telescopic tube 2 produce two images of the viewing object and the surrounding area, and these two images are used to create the stereoscopic viewing material. The DSLR camera 10 must be electronically connected to an image/video display system, which allows the user to view the stereoscopic image produced by the left telescopic tube 1 and the right telescopic tube 2. In addition, the DSLR camera 10 is angled toward the pole 13 by the camera mount 11 so that the DSLR camera 10 is better able to capture the image projected onto the pole 13 and the plate 12. In an alternate embodiment of the present invention shown in FIGS. 10A and 10B, the plate 12 has a large enough thickness to encompass a cavity 12 that serves the same purpose as the pole 13.

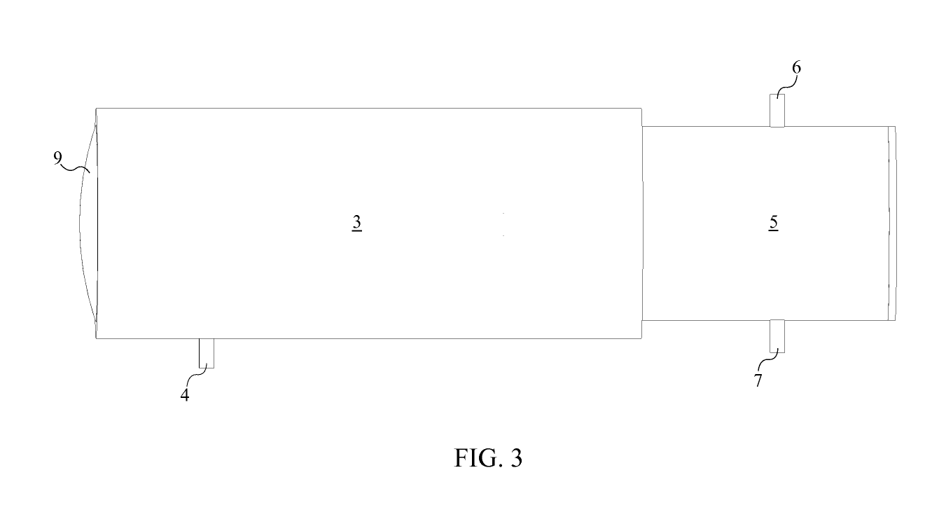

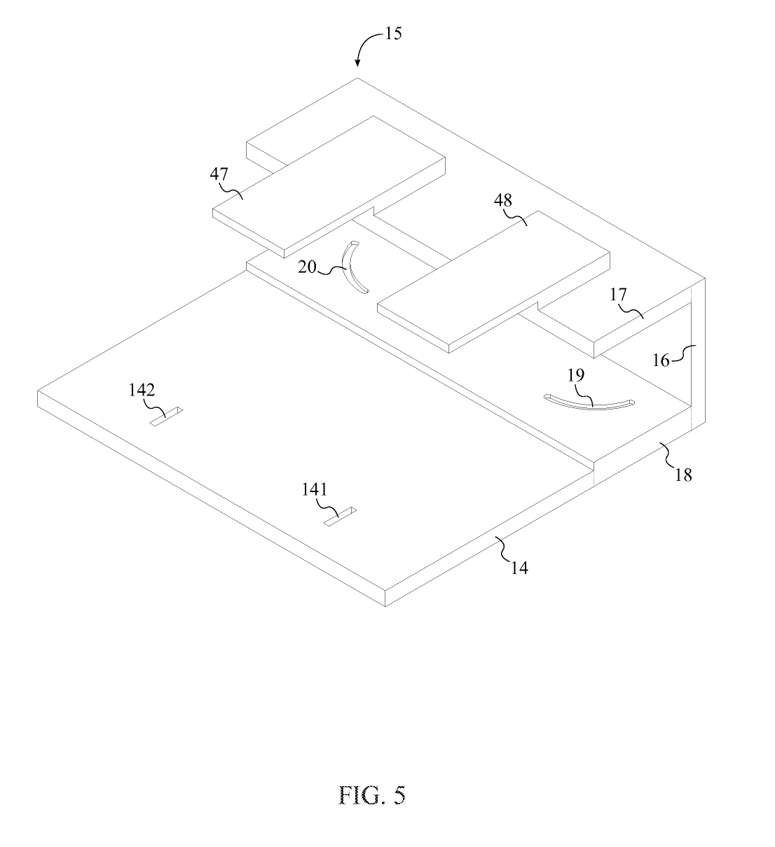

As can be seen in FIG. 5, the platform 14 and the channel 15 provide the present invention with a base that can be used to situate and support all the other components. The left telescopic tube 1 and the right telescopic tube 2 are positioned into the channel 15 in such a way that the channel 15 does not hinder or interfere with the swiveling movement of the left telescopic tube 1 and the right telescopic tube 2. The channel 14 comprises a top flange 17, a web 16, and a bottom flange 18. Typically, the web 16 is positioned in between the top flange 17 and the bottom flange 18 and is perpendicularly connected to the top flange 17 and the bottom flange 18. Naturally, the top flange 17 is positioned above the left telescopic tube 1 and the right telescopic tube 2, and the bottom flange 18 is positioned below the left telescopic tube 1 and the right telescopic tube 2. The top flange 17 and the bottom flange 18 each comprise a left oblique track 19 and a right oblique track 20. The left oblique track 19 and the right oblique track 20 respectively guide the back of the left telescopic tube 1 and the right telescopic tube 2 laterally away from the center of the present invention. In addition, the left oblique track 19 and the right oblique track 20 respectively guide the extension and the contraction of the left telescopic tube 1 and the right telescopic tube 2. The left oblique track 19 of the top flange 17 and the left oblique track 19 of the bottom flange 18 are aligned to each other, which allow the left oblique track 19 to guide the back of the left telescoping tube 1 from both the top and the bottom. Similarly, the right oblique track 20 of the top flange 17 and the right oblique track 20 of the bottom flange 18 are aligned to each other, which allow the right oblique track 20 to guide the back of the right telescoping tube 2 from both the top and the bottom. As can be seen in FIG. 3, the second cylinder 5 comprises a top lateral guide 6 and a bottom lateral guide 7, which are protrusions that are used to engage the left oblique track 19 and the right oblique track 20. Therefore, the top lateral guide 6 of the left telescopic tube 1 engages the left oblique track 19 of the top flange 17, and the bottom lateral guide 7 of the left telescopic tube 1 engages left oblique track 19 of the bottom flange 18. Likewise, the top lateral guide 6 of the right telescopic tube 2 engages the right oblique track 20 of the top flange 17, and the bottom lateral guide 7 of the right telescopic tube 2 engages right oblique track 20 of the bottom flange 18.

In addition to the translational pivoting mount 21, the platform 14 is used to implement a translational pivot point for the front of each telescopic tube. As can be seen in FIG. 3, the first cylinder 3 comprises a bottom pivot 4, which is used by both telescopic tubes to create the translational pivot point. The bottom pivot 4 for both the left telescopic tube 1 and the right telescopic tube 2 is rotatably connected to the platform 14. The bottom pivot 4 of the left telescopic tube 1 is aligned with both left oblique tracks 19, and the bottom pivot 4 of the right telescopic tube 2 is aligned with both right oblique tracks 20, which allows the front and the back of both the telescopic tubes to be properly guided by the bottom pivot 4 and the oblique tracks. In addition, the bottom pivot 4 of both the left telescopic tube 1 and the right telescopic tube 2 is positioned adjacent to each other. The configuration of the bottom pivot 4, the left oblique tracks 19, and the right oblique tracks 20 allows the angle between the left telescopic tube 1 and right telescopic tube 2 to increase when the viewing object is closer to the present invention. In the preferred embodiment of the present invention, the two bottom pivots 4 can be inserted into two female rectangular grooves, which are located adjacent to each other and positioned on the platform 14. The female rectangular grooves would allow for both rotational and linear movement with the two bottom pivots 4. Also in an alternate embodiment of the present invention, the bottom pivots 4 can be inserted two circular grooves, which are located adjacent to each other and positioned on the platform 14. The two circular grooves would allow for only rotational movement with the two bottom pivots 4.

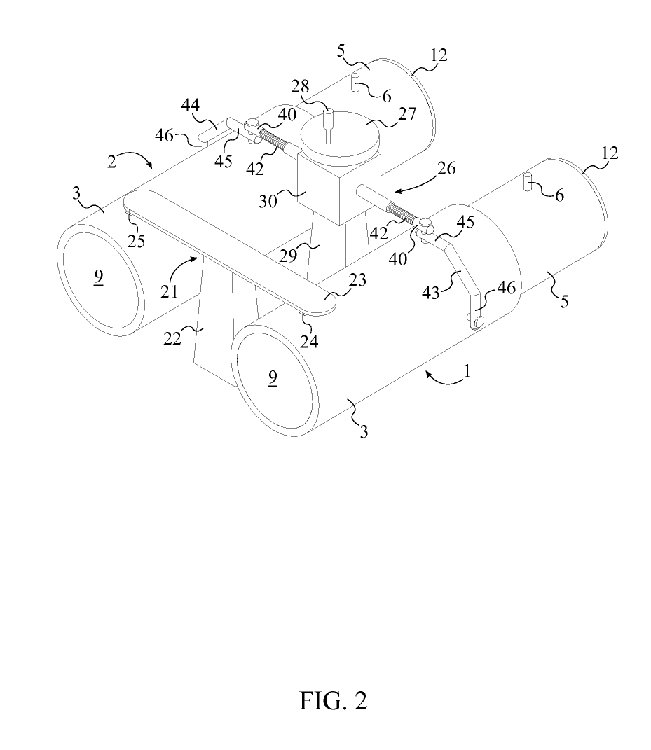

The translational pivoting mount 21 also implements the translational pivot point for the front of each telescopic tube. As can be seen in FIG. 2, the translational pivoting mount 21 comprises a mount base 22, a mount beam 23, a left translational pivot 24, and a right translational pivot 25. The mount base 22 is used to situate the translational pivoting mount 21 on the platform 14, and, thus, the mount base 22 is connected normal to the platform 14 in between the left telescopic tube 1 and the right telescopic tube 1. The mount beam 23 is used to position the left translational pivot 24 above the left telescopic tube 1 and is used to position the right translational pivot 25 above the right telescopic tube 2. Thus, the mount beam 23 is positioned above the left telescopic tube 1 and the right telescopic tube 2, and the left translational pivot 24 and the right translational pivot 25 are positioned opposite to each other along the mount beam 23. In order to situate the mount beam 23, the mount beam 23 is centrally connected to the mount base 22 opposite to the platform 14. The configuration of the components of the translational pivoting mount 21 allows the first cylinder 3 of the left telescopic tube 1 to be pivotally connected to the mount beam 23 by the left translational pivot 24 and allows the first cylinder 3 of the right telescopic tube 2 to be pivotally connect to the mount beam 23 by the right translational pivot 25.

For the left telescopic tube 1, the left translational pivot 24 and the bottom pivot 4 are concentrically positioned to each other in order to form one translational pivot point for the front of the left telescopic tube 1. The bottom pivot 4 of the left telescopic tube 1 is slidably engaged to a left translational groove 141, which traverses into the platform 14 as can be seen in FIG. 5. The bottom pivot 4 of the left telescopic tube 1 is used to match the rotational movement of the left translational pivot 24. The left translational groove 141 is used to match the linear movement of the left translational pivot 24. As a whole, this configuration for the bottom pivot 4 of the left telescopic tube 1 with the left translational groove 141 allows the bottom of the first cylinder 3 to synchronize its movement with the left translational pivot 24. Similarly for the right telescopic tube 2, the right translational pivot 25 and the bottom pivot 4 are concentrically positioned to each other in order to form one translational pivot point for the front of the right telescopic tube 2. The bottom pivot 4 of the right telescopic tube 2 is slidably engaged to a right translational groove 142, which traverses into the platform 14 as can also be in seen FIG. 5. The bottom pivot 4 of the right telescopic tube 2 is used to match the rotational movement of the right translational pivot 25. The right translational groove 142 is used to match the linear movement of the right translational pivot 25. Again, as a whole, this configuration for the bottom pivot 4 of the right telescopic tube 2 with the right translational groove 142 allows the bottom of the first cylinder 3 to synchronize its movement with the right translational pivot 25.

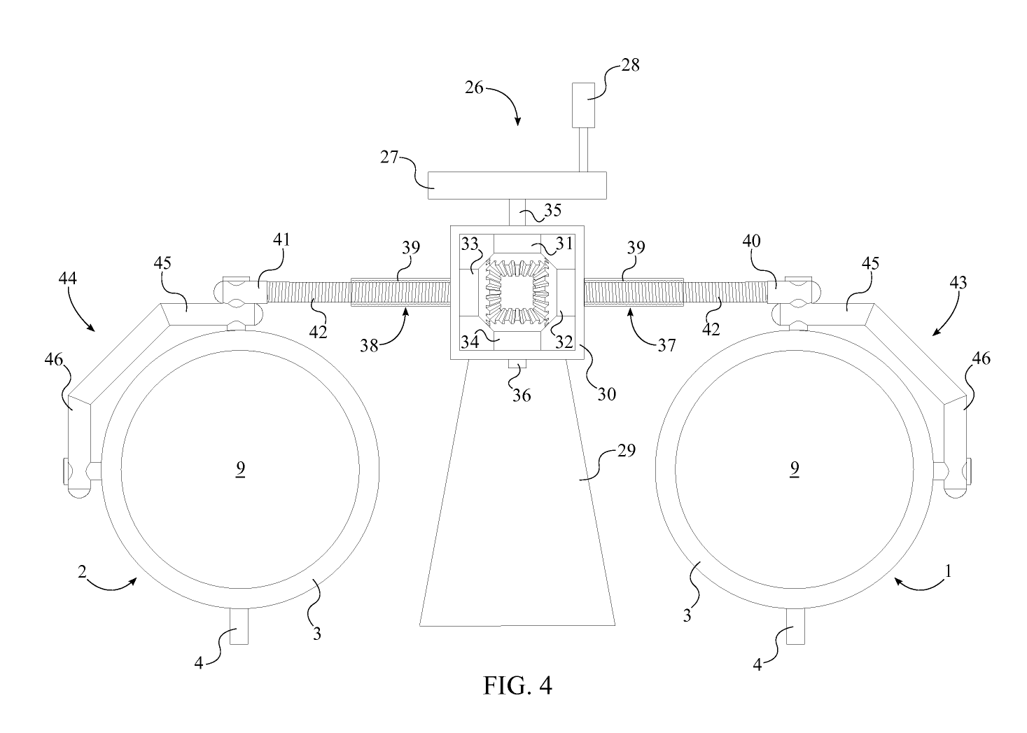

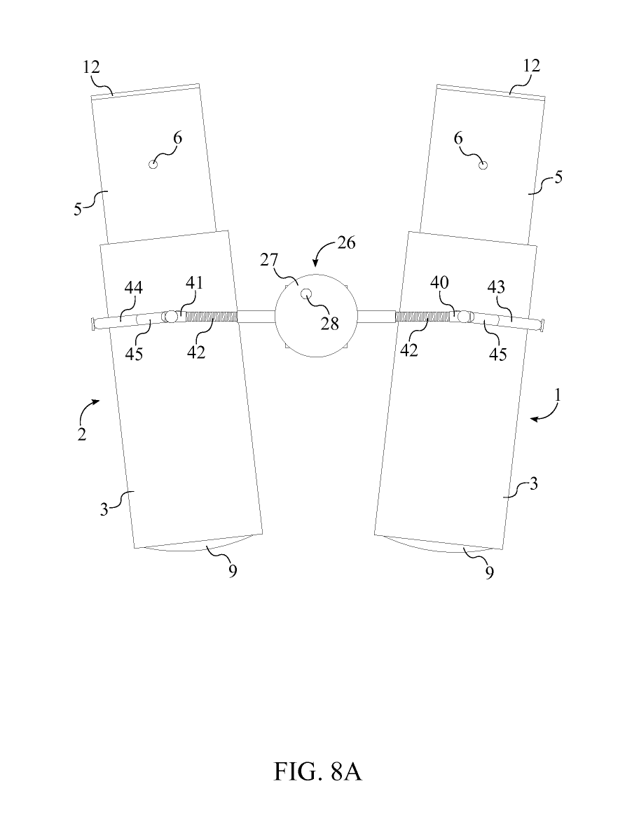

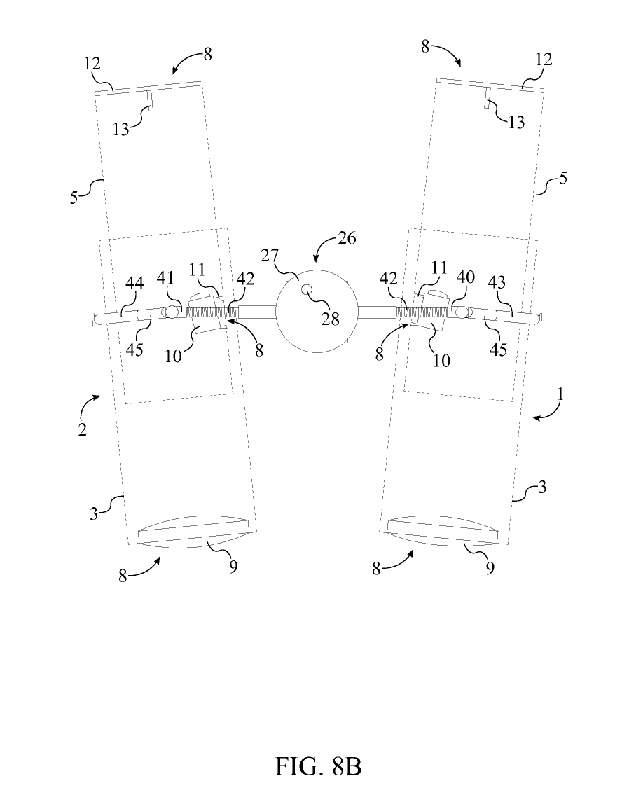

The lateral movement mechanism 26 moves the back of both the telescopic tubes in order to increase or decrease the angle between the left telescopic tube 1 and the right telescopic tube 2, which is shown going from FIGS. 7A and 7B to FIGS. 8A and 8B. In preferred embodiment of the present invention, the lateral movement mechanism 26 comprises a hand wheel 27, a wheel pin 28, a mechanism base 29, a gear enclosure 30, a top bevel gear 31, a left bevel gear 32, a right bevel gear 33, a bottom bevel gear 34, a top gear axle 35, a bottom gear axle 36, a left gear axle 37, a right gear axle 38, a left extension rod 40, a right extension rod 41, a left brace 43, and a right brace 44, all or which is illustrated in FIG. 4. The mechanism base 29 is used to situate the lateral movement mechanism 26 on the platform 14, and, thus, the mechanism base 29 is connected normal to the platform 14 in between the left telescopic tube 1 and the right telescopic tube 2. The gear enclosure 30 is connected to the mechanism base 29 opposite to the platform 14 and is used to prevent damage and misalignment to the bevel gears. The hand wheel 27 is positioned above the gear enclosure 30 and allows the user to provide rotational motion, which can be transformed into linear motion and create lateral movement for the back of both telescopic tubes.

All of the bevel gears are located within the gear enclosure 30. For the configuration of the bevel gears, the left bevel gear 32 is perpendicularly engaged to the top bevel gear 31, and the right bevel gear 33 is perpendicularly engaged to the top bevel gear 31 opposite to the left bevel gear 32. The bottom bevel gear 34 is perpendicularly engaged to both the left bevel gear 32 and the right bevel gear 33 and is positioned opposite to the top bevel gear 31. For the configuration of the gear axles, the top gear axle 35 traverses through the gear enclosure 30 to concentrically connect the hand wheel 27 to the top bevel gear 31. The bottom gear axle 36 allows the bottom bevel gear 34 to be rotatably connected to the gear enclosure 30 adjacent to the mechanism base 29. The left gear axle 37 traverses through the gear enclosure 30 in order to concentrically connect to the left bevel gear 32. Likewise, the right gear axle 38 traverses through the gear enclosure 30 in order to concentrically connect to the right bevel gear 33. In addition, the left gear axle 37 and the right gear axle 38 each comprise a threaded hole 39. The threaded hole 39 of the left gear axle 37 is positioned opposite to the left bevel gear 32, and the threaded hole 39 of the right gear axle 38 is positioned opposite to the right bevel gear 33. The left extension rod 40 and the right extension rod 41 each comprise a threaded portion 42, which respectively engages to the threaded hole 39 of either the left axle gear 37 or the right axle gear 38. The lateral movement mechanism 26 uses the following procedure: first, the user rotates the hand wheel 27, which rotates the top bevel gear 31; second, rotational motion is transferred to the left/right bevel gear 32, 33 and the left/right gear axle 37, 38; third, the bottom bevel gear 34 stabilizes the other bevel gears; fourth, the threaded hole 39 and the threaded portion 42 transforms the rotational motion into linear motion, which moves the left/right extension rod 40, 41 and creates the lateral movement for the left/right telescopic rod 1, 2.

The left brace 43 and the right brace 44 are used to respectively bracket the left telescopic tube 1 and the right telescopic tube 2 so that the lateral movement mechanism 26 can steadily move either the left telescopic tube 1 or the right telescopic tube 2. The left brace 43 and the right brace 44 each comprise a top end 45 and a lateral end 46. For the configuration of the braces, the left brace 43 is positioned around the first cylinder 3 of the left telescopic tube 1. The left extension rod 40 is pivotally connected to the top end 45 of the left brace 43 and to the first cylinder 3 of the left telescopic tube 1. The threaded portion 42 of the left extension rod 40 is also positioned opposite to the top end 45 of the left brace 43. The lateral end 46 of the left brace 43 is connected to the first cylinder 3 of the left telescopic tube 1. Similarly, the right brace 44 is positioned around the first cylinder 3 of the right telescopic tube 3. The right extension rod 41 is pivotally connected to the top end 45 of the right brace 44 and to the first cylinder 3 of the right telescopic tube 2. The threaded portion 42 of the right extension rod 41 is also positioned opposite to the top end of the right brace 44. The lateral end 46 of the right brace 44 is connected to the first cylinder 3 of the right telescopic tube 2.

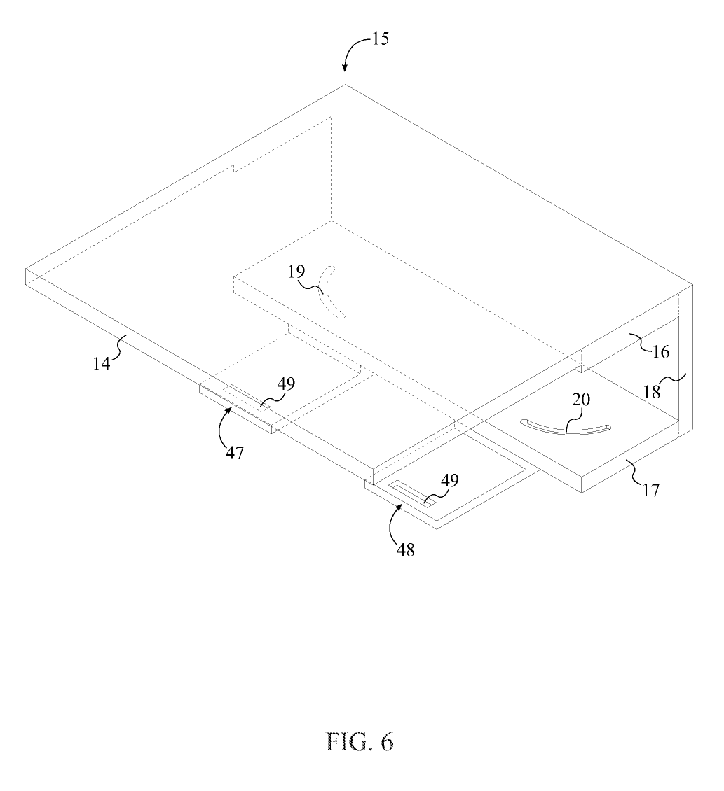

In the preferred embodiment of the present invention shown in FIGS. 1C and 1D, a left strengthening bracket 47 and a right strengthening bracket 48 are respectively used to further stabilize the movements of the left telescopic tube 1 and the right telescopic tube 2. The left strengthening bracket 47 is connected onto the top flange 17 and is positioned to extend over the left telescopic tube 1. Similarly, the right strengthening bracket 48 is connected onto the top flange 17 and is positioned to extend over the right telescopic tube 2. Moreover, the left strengthening bracket 47 and the right strengthening bracket 48 each comprise a groove 49 and a nub 50. The nub 50 is used to mimic the linear and rotational movement of the second cylinder 5 through the lateral movement mechanism 26. More specifically, the nub 50 for the left strengthening bracket 47 is connected onto to the left brace 43, and the nub 50 for the right strengthening bracket 48 is connected onto to the right brace 44. In FIG. 6, the groove 90 is shown to traverse into the strengthening bracket and is used to guide the linear and rotational movement of the second cylinder 5. Thus, the nub 50 is slidable and rotatably engaged to the groove 49, which allows the left strengthening bracket 47 and the right strengthening bracket 48 to respectively stabilize the linear and rotational movements of the second cylinder 5.

In the preferred embodiment, the present invention utilizes different dimensions between certain components. The left translational pivot 24 is positioned seven centimeters from the right translational pivot 25. The distance between the mount beam 23 and the braces is five centimeters.

The following includes some miscellaneous information regarding the preferred embodiment of the present invention. A shorter distance from the DSLR camera 10 to the object being pictured means a longer length from the lens 9 to the plate 12. As these two DSLR cameras 10 focus closer in distance, they swerve toward each other, both focusing on the same spot. The curvature in the left oblique track 19 and the right oblique track 20 allows the present invention to expand the distance between the plate 12 and the DSLR camera 10 relative to the distance of the viewing object from the plate 12. The lenses 9 are at the beginning of the first cylinders 3, the plates 12 are at the back of the second cylinders 5. Within those same second cylinders are the two DSLR cameras 10 that focus on their respective plate 12. Both the forward first cylinders 3 with the lenses 9 and the aft second cylinders 5 with the plates 12 have a male extension on their top and bottom to keep everything in place. As the machine extends outward, the plates 12 curve back as those male extensions are guided by the female lines of the base. At the center of the plates 12, there are the small poles 13 that are raised to the right distance from the lens 9 so that the pole 13 in the center is always a clear picture from the lens 9, and they alone are the only parts clear on the plates 12, and therefore also on an electronic viewing screen. Those are the spots at which the DSLR cameras 10 are always looking. As the receivers of the DSLR cameras 10 are bonded together with a display on the screen for use of the camera person, one knows when to turn the hand wheel 27 for distance; slowly with the hand wheel 27, or faster with a wheel pin 28 around the edge of the hand wheel 27. The plates 12 might be better made as a screen, so that that much less is seen clearly on the side. Experimentation will tell. This type of video taken through the present invention need not be thought of as the machine being used throughout a story, a documentary or movie, but some interesting part within a story; two different “points of view”.

Although the invention has been explained in relation to its preferred embodiment, it is to be understood that many other possible modifications and variations can be made without departing from the spirit and scope of the invention as hereinafter claimed.

What is claimed is:

1. A human-perspective stereoscopic camera comprises,
a left telescopic tube;
a right telescopic tube;
a platform;
a channel;
a translational pivoting mount;
a lateral movement mechanism;
said left telescopic tube and said right telescopic tube each comprise a first cylinder, a second cylinder, and an optics assembly;
said translational pivoting mount comprises a mount base, a mount beam, a left translational pivot, and a right translational pivot;
said first cylinder comprises a bottom pivot;
said second cylinder comprises a top lateral guide and a bottom lateral guide; and
said optics assembly comprises a lens, a digital single-lens reflex (DSLR) camera, a camera mount, a plate, and a pole.

2. The human-perspective stereoscopic camera as claimed in claim 1 comprises,
said second cylinder traversing into said first cylinder;
said second cylinder being sleeved by said first cylinder;
said lens being encircled within said first cylinder opposite to said second cylinder;
said plate being encircled within said second cylinder opposite to said first cylinder;
said DSLR camera being positioned in between said lens and said plate;
said DSLR camera being connected to said second cylinder by said camera mount;
said pole being positioned in between said DSLR camera and said plate;
said pole being centrally positioned and connected normal to said plate; and
said DSLR camera being angled towards said pole by said camera mount.

3. The human-perspective stereoscopic camera as claimed in claim 1 comprises,
said platform being positioned below and parallel to said left telescopic tube and said right telescopic tube;
said second cylinder of said left telescopic tube and said second cylinder of said right telescopic tube traversing into said channel;
said channel being connected adjacent to said platform;
said translational pivoting mount being positioned opposite of said channel along said left telescopic tube and said right telescopic tube;
said lateral movement mechanism being positioned in between said translational pivoting mount and said channel along said left telescopic tube and said right telescopic tube;
said channel comprises a web, a top flange, and a bottom flange; and
said top flange and said bottom flange each comprise a left oblique track and a right oblique track.

4. The human-perspective stereoscopic camera as claimed in claim 3 comprises,
said web being positioned in between said top flange and said bottom flange;
said web being perpendicularly connected to said top flange and said bottom flange;
said top flange being positioned above said left telescopic tube and said right telescopic tube; and
said bottom flange being positioned below said left telescopic tube and said right telescopic tube.

5. The human-perspective stereoscopic camera as claimed in claim 3 comprises,
said left oblique track of said top flange and said left oblique track of said bottom flange being aligned to each other;
said left oblique track of said top flange being engaged by said top lateral guide of said left telescopic tube; and
said left oblique track of said bottom flange being engaged by said bottom lateral guide of said left telescopic tube.

6. The human-perspective stereoscopic camera as claimed in claim 3 comprises,
said right oblique track of said top flange and said right oblique track of said bottom flange being aligned to each other;
said right oblique track of said top flange being engaged by said top lateral guide of said right telescopic tube; and
said right oblique track of said bottom flange being engaged by said bottom lateral guide of said right telescopic tube.

7. The human-perspective stereoscopic camera as claimed in claim 3 comprises,
said bottom pivot of said left telescopic tube being aligned with said left oblique track of said top flange and said left oblique track of said bottom flange;
said bottom pivot of said right telescopic tube being aligned with said right oblique track of said top flange and said right oblique track of said bottom flange;
said bottom pivot of said left telescopic tube being rotatably connected to and slidably engaged into a left translational groove of said platform;
said bottom pivot of said right telescopic tube being rotatably connected to and slidably engaged into a right translational groove of said platform; and
said bottom pivot of said left telescopic tube and said bottom pivot of said right telescopic tube being aligned adjacent to each other.

8. The human-perspective stereoscopic camera as claimed in claim 1 comprises,
said mount base being connected normal to said platform in between said left telescopic tube and said right telescopic tube;
said mount beam being positioned above said left telescopic tube and said right telescopic tube;
said mount beam being centrally connected to said mount base opposite of said platform;
said left translational pivot and said right translational pivot being positioned opposite to each other along said mount beam;
said first cylinder of said left telescopic tube being pivotally connected to said mount beam by said left translational pivot; and
said first cylinder of said right telescopic tube being pivotally connected to said mount beam by said right translational pivot.

9. The human-perspective stereoscopic camera as claimed in claim 1 comprises,
said lateral movement mechanism comprises a hand wheel, a wheel pin, a mechanism base, a gear enclosure, a top bevel gear, a left bevel gear, a right bevel gear, a bottom bevel gear, a top gear axle, a bottom gear axle, a left gear axle, a right gear axle, a left extension rod, a right extension rod, a left brace, and a right brace;
said left gear axle and a right gear axle each comprise a threaded hole;
said left extension rod and said right extension rod each comprise a threaded portion; and
said left brace and said right brace each comprise a top end and a lateral end.

10. The human-perspective stereoscopic camera as claimed in claim 9 comprises,
said mechanism base being connected normal to said platform in between said left telescopic tube and said right telescopic tube;
said gear enclosure being connected to said mechanism base opposite to said platform;
said hand wheel being positioned adjacent to said gear enclosure opposite to said mechanism base; and
said wheel pin being rotatably connected atop said hand wheel.

11. The human-perspective stereoscopic camera as claimed in claim 9 comprises,
said top bevel gear, said bottom bevel gear, said left bevel gear, and said right bevel gear being located within said gear enclosure;
said left bevel gear being perpendicularly engaged to said top bevel gear;
said right bevel gear being perpendicularly engaged to said top bevel gear opposite of said left bevel gear;
said bottom bevel gear being perpendicularly engaged to both said left bevel gear and said right bevel gear opposite to said top bevel gear;
said bottom bevel gear being rotatably connected to said gear enclosure by said bottom gear axle adjacent to said mechanism base;
said top gear axle traversing through said gear enclosure in order to concentrically connect said top bevel gear to said hand wheel;
said left gear axle traversing through said gear enclosure in order to concentrically connect to said left bevel gear;
said right gear axle traversing through said gear enclosure in order to concentrically connect to said right bevel gear;
said threaded hole of said left gear axle being positioned opposite of said left bevel gear; and
said threaded hole of said right gear axle being positioned opposite of said right bevel gear.

12. The human-perspective stereoscopic camera as claimed in claim 9 comprises,
said threaded hole of said left gear axle being engaged by said threaded portion of said left extension rod;
said left brace being positioned around said first cylinder of said left telescopic tube;
said left extension rod being pivotally connected to said top end of said left brace and to said first cylinder of said left telescopic tube, wherein said threaded portion of said left extension rod is positioned opposite to said top end of said left brace;
said lateral end being connected to said first cylinder of said left telescopic tube;
said threaded hole of said right gear axle being engaged by said threaded portion of said right extension rod;
said right brace being positioned around said first cylinder of said right telescopic tube;
said right extension rod being pivotally connected to said top end of said right brace and to said first cylinder of said right telescopic tube, wherein said threaded portion of said right extension rod is positioned opposite to said top end of said right brace; and
said lateral end being connected to said first cylinder of said right telescopic tube.

13. A human-perspective stereoscopic camera comprises,
a left telescopic tube;
a right telescopic tube;
a platform;
a channel;
a translational pivoting mount;
a lateral movement mechanism;
said left telescopic tube and said right telescopic tube each comprise a first cylinder, a second cylinder, and an optics assembly;
said translational pivoting mount comprises a mount base, a mount beam, a left translational pivot, and a right translational pivot;
said first cylinder comprises a bottom pivot;
said second cylinder comprises a top lateral guide and a bottom lateral guide;
said optics assembly comprises a lens, a digital single-lens reflex (DSLR) camera, a camera mount, a plate, and a pole;
said second cylinder traversing into said first cylinder;
said second cylinder being sleeved by said first cylinder;
said lens being encircled within said first cylinder opposite to said second cylinder;
said plate being encircled within said second cylinder opposite to said first cylinder;
said DSLR camera being positioned in between said lens and said plate;
said DSLR camera being connected to said second cylinder by said camera mount;
said pole being positioned in between said DSLR camera and said plate;
said pole being centrally positioned and connected normal to said plate;
said DSLR camera being angled towards said pole by said camera mount;
said platform being positioned below and parallel to said left telescopic tube and said right telescopic tube;
said second cylinder of said left telescopic tube and said second cylinder of said right telescopic tube traversing into said channel;
said channel being connected adjacent to said platform;
said translational pivoting mount being positioned opposite of said channel along said left telescopic tube and said right telescopic tube;
said lateral movement mechanism being positioned in between said translational pivoting mount and said channel along said left telescopic tube and said right telescopic tube;
said mount base being connected normal to said platform in between said left telescopic tube and said right telescopic tube;
said mount beam being positioned above said left telescopic tube and said right telescopic tube;
said mount beam being centrally connected to said mount base opposite of said platform;
said left translational pivot and said right translational pivot being positioned opposite to each other along said mount beam;
said first cylinder of said left telescopic tube being pivotally connected to said mount beam by said left translational pivot; and
said first cylinder of said right telescopic tube being pivotally connected to said mount beam by said right translational pivot.

14. The human-perspective stereoscopic camera as claimed in claim 13 comprises,
said channel comprises a web, a top flange, and a bottom flange;
said top flange and said bottom flange each comprise a left oblique track and a right oblique track;
said web being positioned in between said top flange and said bottom flange;
said web being perpendicularly connected to said top flange and said bottom flange;
said top flange being positioned above said left telescopic tube and said right telescopic tube; and
said bottom flange being positioned below said left telescopic tube and said right telescopic tube.

15. The human-perspective stereoscopic camera as claimed in claim 14 comprises,
said left oblique track of said top flange and said left oblique track of said bottom flange being aligned to each other;
said left oblique track of said top flange being engaged by said top lateral guide of said left telescopic tube;
said left oblique track of said bottom flange being engaged by said bottom lateral guide of said left telescopic tube;
said right oblique track of said top flange and said right oblique track of said bottom flange being aligned to each other;
said right oblique track of said top flange being engaged by said top lateral guide of said right telescopic tube; and
said right oblique track of said bottom flange being engaged by said bottom lateral guide of said right telescopic tube.

16. The human-perspective stereoscopic camera as claimed in claim 14 comprises,
said bottom pivot of said left telescopic tube being aligned with said left oblique track of said top flange and said left oblique track of said bottom flange;
said bottom pivot of said right telescopic tube being aligned with said right oblique track of said top flange and said right oblique track of said bottom flange;
said bottom pivot of said left telescopic tube and said bottom pivot of said right telescopic tube being rotatably connected to said platform; and
said bottom pivot of said left telescopic tube and said bottom pivot of said right telescopic tube being aligned adjacent to each other.

17. The human-perspective stereoscopic camera as claimed in claim 13 comprises,
said lateral movement mechanism comprises a hand wheel, a wheel pin, a mechanism base, a gear enclosure, a top bevel gear, a left bevel gear, a right bevel gear, a bottom bevel gear, a top gear axle, a bottom gear axle, a left gear axle, a right gear axle, a left extension rod, a right extension rod, a left brace, and a right brace;
said left gear axle and a right gear axle each comprise a threaded hole;
said left extension rod and said right extension rod each comprise a threaded portion;
said left brace and said right brace each comprise a top end and a lateral end;
said mechanism base being connected normal to said platform in between said left telescopic tube and said right telescopic tube;
said gear enclosure being connected to said mechanism base opposite to said platform;
said hand wheel being positioned adjacent to said gear enclosure opposite to said mechanism base; and
said wheel pin being rotatably connected atop said hand wheel.

18. The human-perspective stereoscopic camera as claimed in claim 17 comprises,
said top bevel gear, said bottom bevel gear, said left bevel gear, and said right bevel gear being located within said gear enclosure;
said left bevel gear being perpendicularly engaged to said top bevel gear;
said right bevel gear being perpendicularly engaged to said top bevel gear opposite of said left bevel gear;
said bottom bevel gear being perpendicularly engaged to both said left bevel gear and said right bevel gear opposite to said top bevel gear;
said bottom bevel gear being rotatably connected to said gear enclosure by said bottom gear axle adjacent to said mechanism base;
said top gear axle traversing through said gear enclosure in order to concentrically connect said top bevel gear to said hand wheel;
said left gear axle traversing through said gear enclosure in order to concentrically connect to said left bevel gear;
said right gear axle traversing through said gear enclosure in order to concentrically connect to said right bevel gear;
said threaded hole of said left gear axle being positioned opposite of said left bevel gear;
said threaded hole of said right gear axle being positioned opposite of said right bevel gear;
said threaded hole of said left gear axle being engaged by said threaded portion of said left extension rod;
said left brace being positioned around said first cylinder of said left telescopic tube;
said left extension rod being pivotally connected to said top end of said left brace and to said first cylinder of said left telescopic tube, wherein said threaded portion of said left extension rod is positioned opposite to said top end of said left brace;
said lateral end being connected to said first cylinder of said left telescopic tube;
said threaded hole of said right gear axle being engaged by said threaded portion of said right extension rod;
said right brace being positioned around said first cylinder of said right telescopic tube;
said right extension rod being pivotally connected to said top end of said right brace and to said first cylinder of said right telescopic tube, wherein said threaded portion of said right extension rod is positioned opposite to said top end of said right brace; and
said lateral end being connected to said first cylinder of said right telescopic tube.
